(19) United States
(12) Patent Application Publication
(10) Pub. No.: US 2012/0102816 A1
(43) Pub. Date: May 3, 2012

(54) Apparatus and method for baiting a fishhook

(76) Inventor: Rudolph Newman, Anchorage, AK (US)

(21) Appl. No.: 12/925,896

(22) Filed: Nov. 1, 2010

(51) Int. Cl. A01K 85/01; A01K 83/06

(52) U.S. Cl. 43/42.06; 43/44.2

(57) ABSTRACT

An apparatus for baiting a fishhook which comprises a rectangular sponge block having a plurality of equally spaced apart vertical and horizontal partial cut lines therethrough forming a plurality of sponge cubes throughout the rectangular sponge block. One sponge cube can be removed from the rectangular sponge block, placed onto a barb of the fishhook attached to a fish line and immersed into a liquified fish attracting substance ready to be used to catch a fish.

### BACKGROUND OF THE INVENTION

1. Field of the Invention

The present invention relates to a fish baiting system, and more particularly, an apparatus and method for baiting a fishhook.

2. Description of the Prior Art

Numerous innovations for hook baiting and scenting mechanisms have been provided in the prior art that will be described. Even though these innovations may be suitable for the specific individual purposes to which they address, however, they differ from the present invention.

A FIRST EXAMPLE, U.S. Pat. No. 3,940,869, Issued on Mar. 2, 1976, to Roberts teaches an artificial lure and process for forming same is disclosed herein. The lure results from the steps of cutting a strip from a sheet of compressed cellular material or sponge of the type which expands to at least twice its thickness when added to water. A fishing hook is inserted into the compressed dehydrated material and the combination is immersed in water which causes the compressed dehydrated material to expand to form an artificial fishing lure. The sponge may be cut into a simple elongated rectangle or may contain one or more curves to enhance the movement of the lure in water. A fish attracting substance may be added to the water prior to the expansion step. The use of compressed cellulosic sponge of the type which expands to approximately eight times its original thickness after immersion in water is also disclosed herein.

A SECOND EXAMPLE, U.S. Pat. No. 4,788,788, Issued on Dec. 6, 1988, to Brockett teaches a catfish bait holder which utilizes a conventional treble hook having an elongated shank secured to a leader. A cylindrical sponge having a central axial hole is positioned around the shank of the hook. An elongated hollow cylinder formed from an open mesh net material surrounds the cylindrical sponge and is in co-axial alignment therewith. The internal diameter of the hollow mesh cylinder and the external diameter of the cylindrical sponge are substantially equal so that the mesh cylinder is retained in position by frictional engagement with the sponge. In use, the mesh cylinder is filled with a viscous bait paste, which oozes out of the mesh cylinder and provides a chumming effect. In a second embodiment of the invention, the mesh cylinder is provided with an enclosed conical tapered top portion and the cylindrical sponge is provided with a plurality of circumferentially spaced radially extending projections for engagement with the open mesh cylinder. These projections serve to retain the mesh cylinder in position around the sponge.

A THIRD EXAMPLE, U.S. Pat. No. 4,799,328, Issued on Jan. 24, 1989, to Goldman teaches a scent emitting fishing bobber having flow regulation ports and an absorptive compressive material for holding the scent substance. A retention-pressure plate moves between an advanced position wherein the absorptive material is compressed and a retracted position which closes the scent substance inlet.

A FOURTH EXAMPLE, U.S. Pat. No. 4,875,305, Issued on Oct. 24, 1989, to Bridges teaches a fishing lure having a fish attractant body which is formed of a water soluble polymer having a slow dissolution rate. The polymer contains a fish scent attractant. The fish scent attractant can be encapsulated within the polymer, e.g., fish or blood meal can be included in the polymer so that it will be slowly dispensed into the water as the polymer dissolves. The preferred polymer is polyvinyl alcohol having a preselected degree of hydrolysis of its ester groups to achieve the desired water solubility rate, and optionally plasticized with glycerol. The attractant can be a sheet which has a plurality of parallel and coextensive slits to provide parallel strips that depend from an unslit portion thereby permitting the sheet material to be wrapped about a lure body and secured in place so that the parallel strips extend rearwardly from the body, permitting them to undulate in the water as the lure is pulled through the water simulating the swimming movements of a small fish. Other embodiments include solid form lures shaped from polyvinyl alcohol which is gelled with a soluble borate.

A FIFTH EXAMPLE, U.S. Pat. No. 4,882,872, Issued on Nov. 28, 1989, to Todd teaches a storage container adapted for storing live bait such as worms and for convenient carrying by the user includes a container with slit-like openings to provide proper bait aeration and a closure panel for opening and closing the container to provide easy access to the interior thereof. A moisture storage device in the form of a frozen moisture containing sponge which distributes cool moisture to the contents of the storage container as the sponge thaws releasing its moisture.

A SIXTH EXAMPLE, U.S. Pat. No. 4,887,376, Issued on Dec. 19, 1989, to Sibley et al. teaches an invention which supplies lures whose polymer being applied to fish attractants and release the attractant into water at an essentially controlled rate usually for a period sufficient for the attractant fish to arrive at the lure. These polymers may be any that are commercially available or known that has the ability to selectively absorb the lure and then release it controllably into water. The preferred polymers are copolymers of acrylic water swellable polyesters, water swellable polyesthers, water swellable poly urethanes, with the degree of water swellability being controlled by the degree of cross-linking.

A SEVENTH EXAMPLE, U.S. Pat. No. 5,170,582, Issued on Dec. 15, 1992, to Morgin et al. teaches a liquid fish attracting substance that is arranged for application to artificial or cut bait. Fish attractant of a plurality of categories is arranged for selective application to fish bait and onto an individual's fingers to minimize contamination of the scented bait utilized in a fishing scenario. The arrangement includes a plurality of drawer members slidably mounted within a container to permit application of one or a plurality of fish scents to various categories of bait.

AN EIGHTH EXAMPLE, U.S. Pat. No. 5,276,993, Issued on Jan. 11, 1994, to Rosenblatt teaches a fishing lure which is wholly or in part comprised of hydroxylated polyvinyl acetal sponge. The sponge may include a fish attractant. The lure looks and may smell like natural bait, and achieves a desired more natural action of a lure with a much longer lived attractant functionality.

It is apparent now that numerous innovations for hook baiting and scenting mechanisms have been provided in the prior art that are adequate for various purposes. Furthermore, even though these innovations may be suitable for the specific individual purposes to which they address, accordingly, they would not be suitable for the purposes of the present invention as heretofore described.

### SUMMARY OF THE INVENTION

AN OBJECT of the present invention is to provide an apparatus and method for baiting a fishhook that avoids the disadvantages of the prior art.

ANOTHER OBJECT of the present invention is to provide an apparatus and method for baiting a fishhook that is simple and inexpensive to manufacture.

STILL ANOTHER OBJECT of the present invention is to provide an apparatus and method for baiting a fishhook that is simple to use.

BRIEFLY STATED, STILL YET ANOTHER OBJECT of the present invention is to provide an apparatus for baiting a fishhook which comprises a rectangular sponge block having a plurality of equally spaced apart vertical and horizontal partial cut lines therethrough forming a plurality of sponge cubes throughout the rectangular sponge block. One sponge cube can be removed from the rectangular sponge block, placed onto a barb of the fishhook attached to a fish line and immersed into a liquified fish attracting substance ready to be used to catch a fish.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawings are briefly described as follows:

FIG. 1 is a diagrammatic perspective view of an embodiment of the present invention being a rectangular sponge block;

FIG. 2 is a diagrammatic perspective view, similar to FIG. 1, showing one sponge cube being removed from the rectangular sponge block;

FIG. 3 is a diagrammatic front view taken in the direction of arrow 3 in FIG. 1, with parts broken away, showing where vertical cut lines are made in the rectangular sponge block;

FIG. 4 is a diagrammatic end view taken in the direction of arrow 4 in FIG. 1, showing where horizontal cut lines are made in front and rear portions of the rectangular sponge block;

FIG. 5 is a diagrammatic end view taken in the direction of arrow 5 in FIG. 1, showing where horizontal cut lines are made in a middle portion of the rectangular sponge block, after the rear portion of the rectangular sponge block is hinged down, thereby forming all the sponge cubes throughout the rectangular sponge block;

FIG. 6 is a diagrammatic elevational view, showing a typical amount of fish roe before being processed;

FIG. 7 is a diagrammatic elevational view, showing the fish roe being processed into a bait slurry in a blender;

FIG. 8 is a diagrammatic elevational view, showing the sponge cube on a barb of a fishhook immersed in the bait slurry within a container; and

FIG. 9 is a diagrammatic elevational view, showing the sponge cube on the barb of the fishhook soaked with the bait slurry, ready to be used to catch a fish.

### A MARSHALING OF REFERENCE NUMERALS UTILIZED IN THE DRAWING

10 apparatus
12 fishhook
14 rectangular sponge block of apparatus 10
16 vertical partial cut line in sponge block 14
18 horizontal partial cut line in sponge block 14
20 sponge cube of apparatus 10
22 barb of fishhook 12
24 fish line on fishhook 12
26 liquified fish attracting substance
28 bait slurry for liquified fish attracting substance 26
30 fish roe for bait slurry 28
32 front portion of sponge block 14
34 rear portion of sponge block 14
36 middle portion of sponge block 14
38 blender
40 container

### DETAILED DESCRIPTION OF THE PREFERRED EMBODIMENT

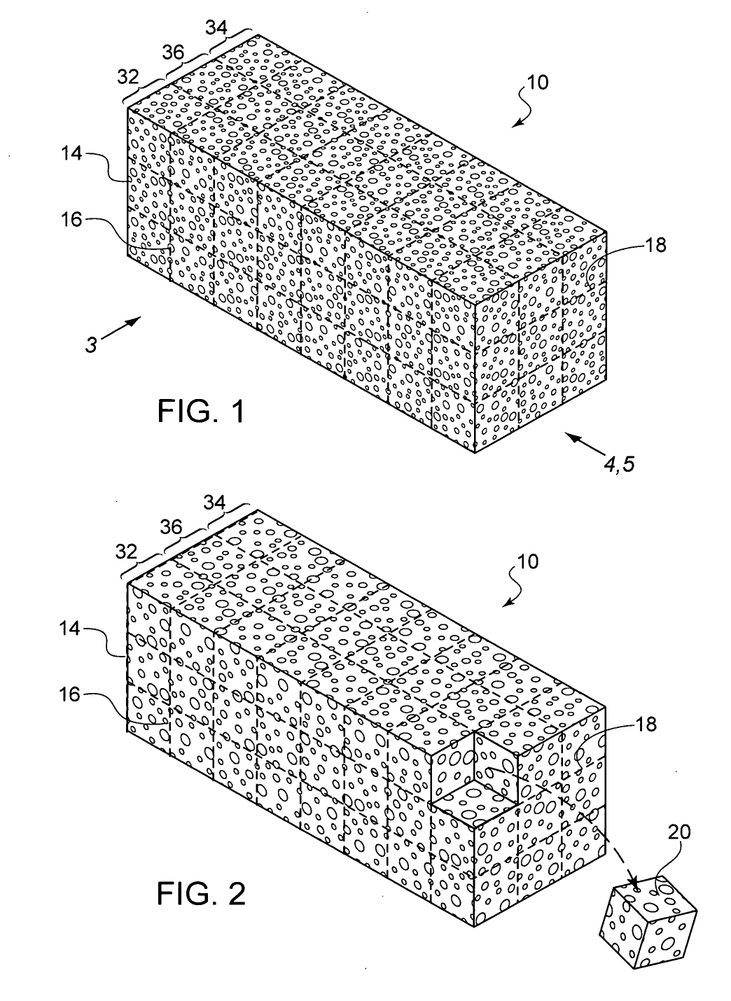

Referring now to the figures, in which like numerals indicate like parts, and particularly to FIGS. 1 through 9, which are a diagrammatic perspective view of an embodiment of the present invention being a rectangular sponge block; a diagrammatic perspective view, similar to FIG. 1, showing one sponge cube being removed from the rectangular sponge block; a diagrammatic front view taken in the direction of arrow 3 in FIG. 1, with parts broken away, showing where vertical cut lines are made in the rectangular sponge block; a diagrammatic end view taken in the direction of arrow 4 in FIG. 1, showing where horizontal cut lines are made in front and rear portions of the rectangular sponge block; a diagrammatic end view taken in the direction of arrow 5 in FIG. 1, showing where horizontal cut lines are made in a middle portion of the rectangular sponge block, after the rear portion of the rectangular sponge block is hinged down, thereby forming all the sponge cubes throughout the rectangular sponge block; a diagrammatic elevational view, showing a typical amount of fish roe before being processed; a diagrammatic elevational view, showing the fish roe being processed into a bait slurry in a blender; a diagrammatic elevational view, showing the sponge cube on a bob of a fishhook immersed in the bait slurry within a container; and a diagrammatic elevational view, showing the sponge cube on the bob of the fishhook soaked with the bait slurry, ready to be used to catch a fish, and as such, will be discussed with reference thereto.

The present invention is an apparatus 10 for baiting a fishhook 12 which comprises a rectangular sponge block 14 having a plurality of equally spaced apart vertical and horizontal partial cut lines 16, 18 therethrough forming a plurality of sponge cubes 20 throughout the rectangular sponge block 14. One sponge cube 20 can be removed from the rectangular sponge block 14, placed onto a barb 22 of the fishhook 12 attached to a fish line 24 and immersed into a liquified fish attracting substance 26 ready to be used to catch a fish. The liquified fish attracting substance 26 is comprises out of a bait slurry 28. The bait slurry 28 is comprised from fish roe 30.

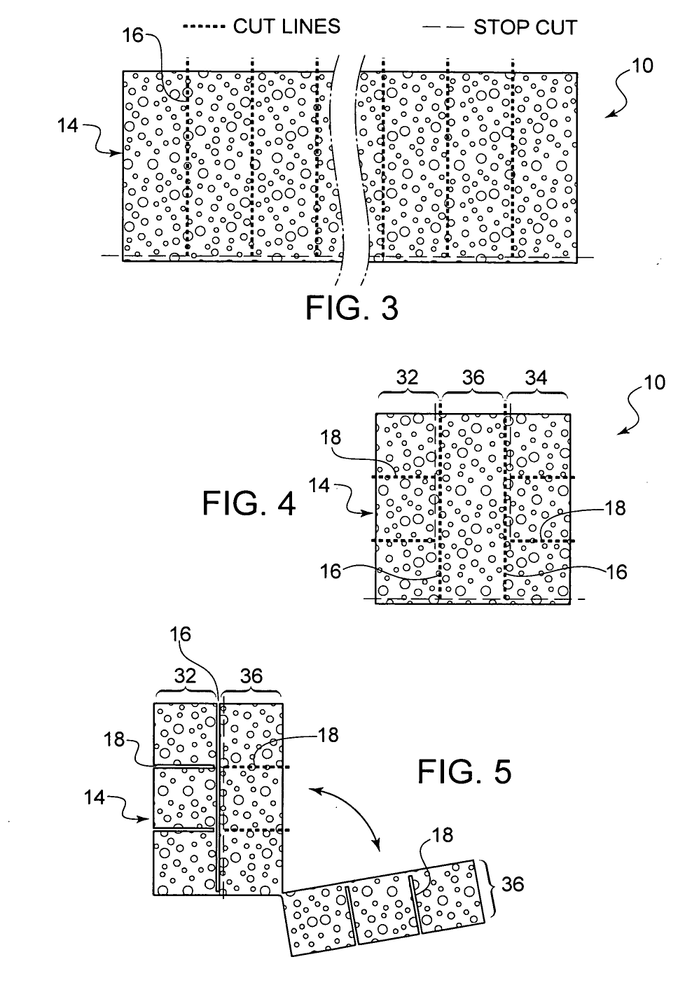

To construct the apparatus 10 the following steps are taken:
1. Provide the rectangular sponge block 14.
2. Make the plurality of equally spaced apart vertical partial cut lines 16 through the rectangular sponge block 14 (See FIG. 3).
3. Produce the plurality of equally spaced apart horizontal partial cut lines 18 in front and rear portions 32, 34 of the rectangular sponge block 14 (See FIG. 4).
4. Pivot down the rear portion 34 of the rectangular sponge block 14.
5. Produce the plurality of equally spaced apart horizontal partial cut lines 18 in a middle portion 36 of the rectangular sponge block 14, to form the plurality of sponge cubes 20 throughout the rectangular sponge block 14 (See FIG. 5).

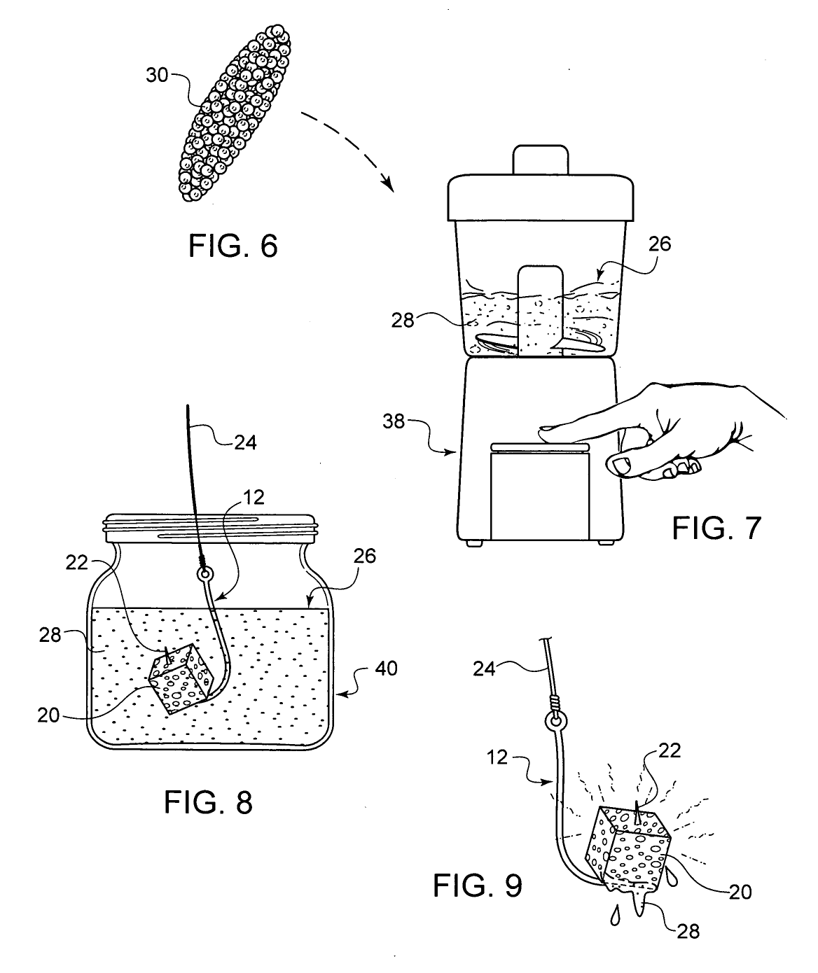

To use the apparatus 10 the following steps are taken:
1. Remove one sponge cube 20 from the rectangular sponge block 14 (See FIG. 2).
2. Provide a typical amount of the fish roe 30 (See FIG. 6).
3. Process the fish roe 30 within a blender 38 to form the bait slurry 28 (See FIG. 7).
4. Immerse the sponge cube 20 that is placed on the barb 22 of the fishhook 12 that is attached to the fish line 24 into the bait slurry 28 within a container 40 (See FIG. 8).
5. Remove the sponge cube 20 on the barb 22 of the fishhook 12 that is soaked with the bait slurry 28 out of the container 40, so that it is ready to be used to catch a fish (See FIG. 9).

It will be understood that each of the elements described above, or two or more together, may also find a useful application in other types of constructions differing from the types described above.

While the invention has been illustrated and described as embodiments of an apparatus and method for baiting a fishhook, accordingly it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. An apparatus for baiting a fishhook which comprises a rectangular sponge block having a plurality of equally spaced apart vertical and horizontal partial cut lines therethrough forming a plurality of sponge cubes throughout said rectangular sponge block, wherein one said sponge cube can be removed from said rectangular sponge block, placed onto a barb of the fishhook attached to a fish line and immersed into a liquified fish attracting substance ready to be used to catch a fish.

2. The apparatus as recited in claim 1, wherein said liquified fish attracting substance is comprises out of a bait slurry.

3. The apparatus as recited in claim 2, wherein said bait slurry is comprised from fish roe.

4. A method for baiting a fishhook which comprises the steps of:
a) providing a rectangular sponge block;
b) making a plurality of equally spaced apart vertical partial cut lines through the rectangular sponge block;
c) producing a plurality of equally spaced apart horizontal partial cut lines in front and rear portions of the rectangular sponge block;
d) pivoting down the rear portion of the rectangular sponge block; and
e) producing a plurality of equally spaced apart horizontal partial cut lines in a middle portion of the rectangular sponge block, to form a plurality of sponge cubes throughout the rectangular sponge block.

5. The method as recited in claim 4, further comprising the steps of:
a) removing one sponge cube from the rectangular sponge block;
b) providing a typical amount of fish roe;
c) transforming the fish roe to a bait slurry;
d) immersing the sponge cube that is placed on a barb of the fishhook that is attached to a fish line into the bait slurry within a container; and
e) removing the sponge cube on the barb of the fishhook that is soaked with the bait slurry out of the container, so that it is ready to be used to catch a fish.
